(19) United States
(12) Patent Application Publication
(10) Pub. No.: US 2010/0068421 A1
(43) Pub. Date: Mar. 18, 2010

(54) LIGHT DIFFUSIVE PRESSURE SENSITIVE ADHESIVE

(75) Inventors: Kiu-Yuen Tse, Woodbury, MN (US); Jianhui Xia, Woodbury, MN (US); Mark D. Purgett, Oakdale, MN (US); Andrew Satrijo, St. Paul, MN (US); Albert I. Everaerts, Oakdale, MN (US); Ming Cheng, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/560,646

(22) Filed: Sep. 16, 2009

Related U.S. Application Data
(60) Provisional application No. 61/097,685, filed on Sep. 17, 2008.
(60) Provisional application No. 61/111,120, filed on Nov. 4, 2008.

(51) Int. Cl. C08G 63/00; C08L 67/00; C08K 5/16; C09K 19/00; B05D 5/06

(52) U.S. Cl. 428/1.54; 528/271; 524/599; 524/227; 427/162

(57) ABSTRACT

The present disclosure provides for a light diffusing pressure sensitive adhesive and a method of making the same. In applications where there is a point light source such as a light bulb or an light emitting diode (LED), or a series of such point light sources, and it is desirable to diffuse the light from the point source to produce a desirable background brightness. The light diffusive PSA disclosed herein is reworkable; has a luminous transmission of grater than 80%, as measured according to ASTM D 1003-95-5; has a haze value not less than 20%; and has a depolarization of less than about 10%, as measured using wavelength in the visible spectrum.

### CROSS REFERENCE TO RELATED APPLICATION

This application claims the benefit of U.S. Provisional Patent Application Nos. 61/097,685 filed on Sep. 17, 2008 and 61/111,120 filed on Nov. 4, 2008, both of which are incorporated by reference in their entirety.

### FIELD OF THE DISCLOSURE

The present disclosure relates to adhesives that have optical diffusive properties. In particular, the present disclosure relates to pressure sensitive adhesive made using a solventless adhesive matrix system that cures upon exposure to actinic radiation.

### BACKGROUND

Information displays, such as liquid crystal displays and rear projection screens, often rely on light-diffusing optical constructions for efficient operation and enhanced readability. Such light-diffusing constructions assume critical roles in these displays by forward scattering the light from a source without a significant loss in the intensity of the forward scattered light. This scattered, yet high transmittance, resultant light gives such displays desirable background brightness by reducing the amount of incident light which is scattered or reflected back toward the light source. Elimination or restriction of such “backscattered” light is a key factor in designing these light-diffusing constructions. Diffusers can be incorporated into optical systems by adding an additional diffuser component to the system, or, in some cases, by incorporating diffusive properties into an existing component.

Adding additional components to an optical system has the disadvantage of introducing additional absorption and creating additional interfaces that can reflect light, thereby causing loss of illumination and other forms of image degradation. Additionally, in some multilayer systems it may be difficult or impossible to add additional components.

There have been attempts to by those skilled in the art to develop adhesive with diffusive properties.

For example, U.S. Pat. No. 6,288,172 B1 (Goetz et al.) discloses a light diffusing adhesive comprising a mixture of a pressure sensitive adhesive (PSA) matrix having a refractive index n₁ filled with organic, polymeric microparticles having a refractive index n₂ such that the absolute value of n₁−n₂ is greater than 0 and typically in the range of 0.01 to 0.2. The pressure sensitive adhesive matrix can be coated on a suitable backing by conventional coating techniques, such as knife coating or Meyer bar coating or use of an extrusion die. U.S. Pat. No. 6,621,635 B1 (Yano) discloses a diffusing adhesive layer that has a light-transmissible adhesive layer dispersively containing colorless light-transmissible particles so as to exhibit light diffusing characteristics. Publication US 2007/0267133 A1 (Matano et al.) discloses a PSA for applying an optically functional film where adhesion can be carried out with good durability in adhesion of a polarizing plate. The PSA comprises preferably (A) an acrylic comonomer and (B) an active beam-curable compound.

### SUMMARY

In one aspect, the present disclosure provides for a light diffusive PSA made from acrylic-based monomers where the PSA can be advantageously produced from a solventless system. The PSA exhibit performance features important to electronic display applications. In particular, the light diffusive PSA disclosed herein is reworkable; has a luminous transmission of greater than 80%, as measured according to ASTM D 1003-95-5; has a haze value not less than 20%; and has a depolarization of less than about 10%, as measured using wavelength in the visible spectrum (about 400 to 700 nanometer). The light diffusing pressure sensitive adhesive comprises or consists essentially of (i) an adhesive matrix having a first refractive index n₁ and comprising no greater than about 20 parts by weight of at least one of a radically polymerizable hydroxyl-containing monomer and a radically polymerizable acid-containing monomer and less than about 100 parts by weight of an alkyl (meth)acrylate monomer, wherein the alkyl groups comprise from about 4 to 12 carbon atoms; (ii) no greater than about 75 parts light diffusing particles dispersed in the adhesive matrix and having a second refractive index n₂ that differs from n₁; and (iii) optionally about 0.1 to 10 parts of an antistatic agent based on the weight of the adhesive matrix. In one embodiment, the absolute value of the difference between the two refractive indices (i.e., |n₁−n₂|) ranges from about 0.01 to 0.20.

As used in this document, the term “reworkable” as used to describe the light diffusive PSA of this present disclosure, means generally that a substrate (such as the liquid crystal cell or a polarizer) is not substantially damaged when the adhesive is removed therefrom and no significant amount of adhesive residue remains on the substrate. For a PSA to reworkable, it typically will have 180° peel adhesion value of less than about 60 ounces per inch (16.4N/25 mm) at a peel rate of about 12 inches per minute after about 48 hours of dwell at 50° C. on glass. In a preferred embodiment, the PSA has 180° peel adhesion value of less than about 30 ounces per inch (8.2N/25 mm) at a peel rate of about 12 inches per minute after about 48 hours of dwell at 50° C. on glass. For example, in LCD assembly applications it may be desirable or necessary to remove the polarizer layer, such as when the initial construction is not completely satisfactory. In this case, the adhesion level of the light diffusive PSA disclosed herein should allow the polarizer and the LCD to be separated without damaging the LCD. Thus, the initial adhesion level of the light diffusive PSA should be sufficient to hold the assembly together, but the adhesion level should not increase over time to such a high level that, if rework is necessary, the LCD may be damaged when the polarizer layer is removed. In addition, the light diffusive PSA should have sufficient cohesive strength that no residue remains on the LCD when the adhesive and polarizer are removed. Furthermore, the adhesive strength of the light diffusive PSA should not exceed the tear strength of the polarizer, so the polarizer and adhesive can be removed together without tearing the polarizer.

In another aspect, the present disclosure is directed to a method of making a light diffusive pressure sensitive adhesive using solventless system. The method comprises the steps of (a) providing a solventless syrup having a first refractive index n₁ and comprising (i) a monomer mixture having no greater than about 20 parts by weight of at least one of a radically polymerizable hydroxyl-containing monomer and a radically polymerizable acid-containing monomer and less than about 100 parts by weight of an alkyl (meth)acrylate monomer, wherein the alkyl group comprises from about 4 to 12 carbon atoms; and (ii) about 0.1 to 5 parts photoinitiator; (b) partially polymerizing the solventless syrup by exposing it to actinic radiation; (c) providing a solventless bead dispersion comprising no greater than about 75 parts light diffusing particles having a second refractive index n₂ that differs from n₁, the particles dispersed in the monomer mixture; (d) providing a photoinitiator solution comprising from about 0.1 to 10 parts of a photoinitiator in the monomer mixture; (e) providing a salt solution comprising from about 0.01 to 20 parts of an organic-soluble and dissociable salt in the monomer mixture; (f) providing a crosslinker solution comprising from about 0.1 to 5 part crosslinker in the monomer mixture, wherein the parts of the photoinitiator, salt, and crosslinker are based on the weight of the monomer mixture; (g) mixing the partially polymerized solventless syrup, solventless bead dispersion, photoinitiator solution, salt solution, and crosslinker to yield an adhesive composition; coating the adhesive composition on a first side of a first backing; and curing the adhesive composition using actinic radiation to yield a light diffusing pressure sensitive adhesive. Unlike publication US 2007/0267133 (Matano et al.), curing step disclosed herein uses a lamp intensity of no greater than about 50 mW/cm² and a energy dose of about 800 to 3,000 mJ/cm² as compared to Matano's reported values of lamp intensity of 600 mW/cm² and an energy dose of 150 mJ/cm².

The light diffusive PSA disclosed herein can be used to make optical articles. Such articles may include an optical film, a substrate or both. The light diffusive adhesive PSA is particularly useful in applications in which a separate diffuser layer or film is currently used. Diffusive layers are used, e.g., in applications where there is a point light source such as a light bulb or an light emitting diode (LED), or a series of such point light sources, and it is desirable to diffuse the light from the point source to produce a desirable background brightness. Such uses include information displays, such as liquid crystal displays, light boxes for graphic displays, and rear projection screens.

### DETAILED DESCRIPTION

All numbers are herein assumed to be modified by the term “about.” The recitation of numerical ranges by endpoints includes all numbers subsumed within that range (e.g., 1 to 5 includes 1, 1.5, 2, 2.75, 3, 3.80, 4, and 5). Percentages of material amounts are by weight unless otherwise indicated.

### Adhesive Matrix

The adhesive matrix of the present disclosure contains essentially no solvent. As further described below in the Method of Making portion of this disclosure, the light diffusive PSA is prepared using solventless techniques. The adhesive matrix includes less an about 100 parts of an alkyl (meth)acrylate monomer and no greater than about 20 parts of at least one of a radically polymerizable hydroxyl-containing monomer and a radically polymerizable acid-containing monomer, such as, e.g., 2-hydroxyethyl (meth)acrylate, hydroxylpropyl (meth)acrylate, hydroxybutyl acrylate, hydroxyhexyl acrylate, or acrylic acid. The term “(meth)acrylate” includes both acrylate and methacrylate.

To achieve pressure sensitive adhesive characteristics, the adhesive matrix can be tailored to have a resultant glass transition temperature (T_{g}) of less than about 0° C. Particularly preferred pressure sensitive adhesive copolymers are (meth)acrylate copolymers. Such copolymers typically are derived from monomers comprising 40% to 98% by weight, often at least 70%, or at least 85%, or even about 90% by weight, of at least one alkyl (meth)acrylate monomer that, as a homopolymer, has a T_{g} of less than 0° C.

Suitable such alkyl (meth)acrylate monomers include those having alkyl groups containing from 4 carbon to 12 carbon atoms. Examples include, but are not limited to, n-butyl acrylate, 2-ethylhexyl acrylate, isooctyl acrylate, isononyl acrylate, isodecyl acrylate, and mixtures thereof. Optionally, other vinyl monomers and alkyl (meth)acrylate monomers which, as homopolymers, have a T_{g} greater than 0° C., such as methyl acrylate, methyl methacrylate, isobornyl acrylate, vinyl acetate, styrene, and the like, may be utilized in conjunction with one or more of the low T_{g} alkyl (meth)acrylate monomers and copolymerizable basic or acidic monomers, provided that the T_{g} of the resultant (meth)acrylate copolymer is less than about 0° C.

The optically clear pressure sensitive adhesive matrix generally has a refractive index that is different than the refractive index of the particles blended with it. Typically the optically clear pressure sensitive adhesive matrix has a refractive index in the range of about 1.45-1.56. Many pressure sensitive adhesives have refractive indices of 1.47 or less, but recently pressure sensitive adhesives with higher refractive indices, such as at least 1.48 or even at least 1.50 or greater have been prepared, for example as described in U.S. Pat. No. 7,166,686 (Olson et al.).

### Light Diffusing Particles

A solventless bead dispersion prepared herein comprises no greater than about 75 parts light diffusing particles dispersed in the monomer mixture. A variety of different particles are suitable for use in the adhesive matrix to form the diffusive adhesives of this disclosure as long as the particles can withstand the preparation and coating conditions and have a refractive index which is different than (lower or higher) the refractive index for the adhesive matrix. Typically, the refractive index of the particles is in the range of 1.30 to 1.60. The particles may be in a variety of shapes, but typically the particles are spherical or generally spherically shaped.

Among the classes of particles that are suitable are silicone resin particles, which are sometimes called polymethylsilsesquiloxane particles. Some of these silicone resin particles are crosslinked. It may be desirable for the particles to be crosslinked to avoid dissolving or minimizing swelling of mixtures of monomers which are present in the adhesive matrix.

A range of silicone resin particles are commercially available from Momentive Performance Materials under the trade name “TOSPEARL”. Among the TOSPEARL particles suitable include, e.g., TOSPEARL 120, TOSPEARL 120A, TOSPEARL 130, TOSPEARL 130A, TOSPEARL 145, TOSPEARL 145A, TOSPEARL 240, TOSPEARL 3120, TOSPEARL 2000B, TOSPEARL 3000A, TOSPEARL 1110A.

Other useful particles are described in U.S. Pat. No. 6,288,172 B1 (Goetz et al.), e.g., in column 5, line 28 to column 6, line 19, which disclosure is incorporated by reference. Yet another useful particle is a polymethylmethacrylate, such as, e.g., MX1000 product from Soken Chemical America.

Typically these particle sizes are larger than the wavelength of visible light (400 to 700 nm). Typically the particles have an average particle size of 0.5 to 30 micrometer. In some embodiment, the average particle size is from 1 to 15 micrometers.

### Photoinitiator

A solventless photoinitiator solution prepared herein comprises no greater than 0.1 to 5 parts added to the monomer mixture, based on the total weight of the monomers used. Examples of useful photoinitiators include benzoin ethers such as benzoin methyl ether and benzoin isopropyl ether; substituted phosphine oxides such as 2,4,6-trimethylbenzoyldiphenylphosphine oxide available as LUCIRIN TPO-L (BASF); substituted acetophenones such as 2,2-diethoxyacetophenone, available as IRGACURE 651 photoinitiator (Ciba; Ardsley, N.Y.), 2,2-dimethoxy-2-phenyl-1-phenylethanone, available as ESACURE KB-1 photoinitiator (Sartomer Co.; West Chester, Pa.), and dimethoxyhydroxyacetophenone; substituted α-ketols such as 2-methyl-2-hydroxy propiophenone; such as 2-naphthalene-sulfonyl chloride; such as 1-phenyl-1,2-propanedione-2-(O-ethoxy-carbonyl)oxime. Particularly useful are the substituted acetophenones or 2,4,6-trimethylbenzoyldiphenylphosphine oxide. The initiator is present in an amount of about 0.05% to about 5.0% by weight based upon the total weight of the monomers.

### Crosslinker

A solventless crosslinker solution prepared herein comprises no greater than 0.01 to 20 parts added to the monomer mixture, based on the total weight of the monomers used. The crosslinking agent is used in an effective amount, meaning an amount that is sufficient to cause crosslinking of the PSA to provide adequate cohesive strength to produce the desired final adhesion properties to the desired substrate.

One class of useful crosslinking agents include multifunctional (meth)acrylate species. Multifunctional (meth)acrylates include tri(meth)acrylates and di(meth)acrylates (that is, compounds comprising three or two (meth)acrylate groups). Typically di(meth)acrylate crosslinkers (that is, compounds comprising two (meth)acrylate groups) are used. Useful tri(meth)acrylates include, for example, trimethylolpropane tri(meth)acrylate, propoxylated trimethylolpropane triacrylates, ethoxylated trimethylolpropane triacrylates, tris(2-hydroxy ethyl)isocyanurate triacrylate, and pentaerythritol triacrylate. Useful di(meth)acrylates include, for example, ethylene glycol di(meth)acrylate, diethylene glycol di(meth)acrylate, triethylene glycol di(meth)acrylate, tetraethylene glycol di(meth)acrylate, 1,4-butanediol di(meth)acrylate, 1,6-hexanediol di(meth)acrylate, alkoxylated 1,6-hexanediol diacrylates, tripropylene glycol diacrylate, dipropylene glycol diacrylate, cyclohexane dimethanol di(meth)acrylate, alkoxylated cyclohexane dimethanol diacrylates, ethoxylated bisphenol A di(meth)acrylates, neopentyl glycol diacrylate, polyethylene glycol di(meth)acrylates, polypropylene glycol di(meth)acrylates, and urethane di(meth)acrylates.

Another useful class of crosslinking agents contain functionality which are reactive with carboxylic acid groups on the acrylic copolymer. Examples of such crosslinkers include multifunctional aziridine, isocyanate and epoxy compounds.

Examples of aziridine-type crosslinkers include
1,4-bis(ethyleneiminocarbonylamino)benzene,
4,4′-bis(ethyleneiminocarbonylamino)diphenylmethane,
1,8-bis(ethyleneiminocarbonylamino)octane, and 1,1′-(1,3-phenylene dicarbony1)-bis-(2-methylaziridine) (CAS No. 7652-64-4), commonly referred to as Bisamide. Common polyfunctional isocyanate crosslinkers include, e.g., trimethylolpropane toluene diisocyanate, tolylene diisocyanate, and hexamethylene diisocyanate.

Other useful class of crosslinking agents include multi-functional isocyanates and epoxides that can react with the functional groups on the adhesive polymer chains.

### Optional Antistatic Agent

An antistatic agent is optionally used in the light diffusive PSA disclosed herein. A solventless salt solution is prepared by adding the organic soluble and dissociable salt (i.e., the antistatic agent) to the monomers disclosed above in the above adhesive matrix.

The antistatic agent operates by removing static charge or by preventing build up of such charge. Useful antistatic agents useful include non-polymeric and polymeric organic salts. Non-polymeric salts have no repeat units. Generally, the antistatic agent comprises less than 10%, optionally less than 5% of the light diffuse PSA. In addition, the antistatic agent comprises greater than 0.5%, optionally greater than 1.0% of the light diffusive PSA. The amount of antistatic agent recited herein is based on the total monomer weight.

When combined with a dissociation enhancing plasticizer described below, the anti-static agent can be used at 10% or less, significantly reducing the cost of the light diffusive PSA and reducing any adverse interaction that may exist between the anti-static agent and the polarizer. In some preferred embodiments, the antistatic salt is a hydrophobic compound. Such hydrophobic antistatic compounds tend to reduce the dependence of the performance of the antistatic compound on humidity while improving compatibility with the pressure sensitive adhesive. In some embodiments, it is preferred that both the anion and the cation making up the antistatic agent are organic in that they both include carbon containing groups and are nominally free of metal ions. Generally, the antistatic agent is added in an amount that will not adversely affect the desired optical clarity of the light diffusive PSA.

The proper antistatic agent for a given adhesive system is chosen by balancing properties in the cations and anions that make up the antistatic agents to achieve solubility in particular cured adhesive formulations. A preferred antistatic agent is lithium bis(thifluoromethyl sulfonyl) imide, Li^{+ -}N(SO₂CF₃)₂. Another preferred organic antistatic agent is (C₄H₉)₃NCH₃^{+ -}N(SO₂CF₃)₂.

One specific class of ionic salts useful in preparing the antistatic agent of the invention is the class of compounds represented by the general formula:

(R₁)ₜ₋ᵥG⁺[(CH₂)_{q}OR₂]ᵥX⁻ (I)

wherein each R₁ comprises alkyl, alicyclic, aryl, alkalicyclic, alkaryl, alicyclicalkyl, aralkyl, aralicyclic, or alicyclicaryl moieties, wherein the moieties may comprise one or more heteroatoms, e.g., nitrogen, oxygen, or sulfur, or may comprise phosphorus, or a halogen (and thus can be fluoro-organic in nature); each R₂ comprises hydrogen or the moieties described above for R₁; G is nitrogen, sulfur or phosphorous; if G is sulfur then t is 3, if G is nitrogen or phosphorous then t is 4; v is an integer of 1 to 3 if G is sulfur, or an integer of 1 to 4 if G is nitrogen or phosphorous; q is an integer of 1 to 4; and X is a weakly coordinating organic anion, such as a fluoro-organic anion. R₁ is preferably alkyl, and R₂ is preferably hydrogen, alkyl, or acyl (more preferably, hydrogen or acyl; most preferably, hydrogen). More detail can of the antistatic agents be found in U.S. Patent Publication 2003/0114560, which is hereby incorporated by reference in its entirety.

Suitable weakly coordinating organic anions have a conjugate acid that is at least as acidic as a hydrocarbon sulfonic acid (for example, a hydrocarbon sulfonic acid having from 1 to about 20 carbon atoms; such as, an alkane, aryl, or alkaryl sulfonic acid having from 1 to about 8 carbon atoms; and in specific examples, methane or p-toluene sulfonic acid; most preferably, p-toluene sulfonic acid). Generally, the conjugate acid is a strong acid. For example, the Hammett acidity function, H, of the neat conjugate acid of the anion is less than about −7 (preferably, less than about −10).

Examples of suitable weakly coordinating anions include organic anions such as alkane, aryl, and alkaryl sulfonates; alkane, aryl, alkaryl sulfates; fluorinated and unfluorinated tetraarylborates; and fluoroorganic anions such as fluorinated arylsulfonates, perfluoroalkanesulfonates, cyanoperfluoroalkanesulfonylamides, bis(cyano) perfluoroalkanesulfonylmethides, bis(perfluoroalkanesulfonyl)imides, cyano-bis-(perfluoroalkanesulfonyl)methides, bis(perfluoroalkanesulfonyl)methides, and tris(perfluoroalkanesulfonyl)methides; and the like.

Other useful organic-soluble and dissociable salt are described in publication US 2008/060075, such as those disclosed in Table 2 under the column “Organic-soluble Salt”, which listing is incorporated by reference.

### Optional Plasticizer

In some embodiments the plasticizer is provided in an effective amount to facilitate salt dissociation and ion mobility for static dissipation properties in the adhesive, for example an amount greater than about 0.01 parts by weight (pbw) based on 100 pbw of acrylic adhesive, optionally an amount greater than about 0.10 pbw and in some embodiments an amount greater than about 1.0 pbw may be used. In addition, in some embodiments the plasticizer may be provided in an effective amount, for example, an amount less than about 20 pbw and optionally an amount less than about 10 pbw. In certain embodiments, the plasticizer may facilitate salt dissociation and ion mobility in the adhesive. In some embodiments, the plasticizer is selected from acrylic soluble plasticizers, including phosphate esters, adipate esters, citrate esters, phthalate esters, phenyl ether terminated oligoethylene oxides. In general, non-hydrophilic plasticizers are preferred. Non-hydrophilic plasticizers generally do not take up moisture from the atmosphere at high humidity and elevated temperatures.

### Optional Adhesion Promoting Additives

Adhesion promoting additives, such as silanes and titanates may also be incorporated into the light diffusive PSA of the present disclosure. Such additives can promote adhesion between the adhesive and the substrates, like the glass and cellulose triacetate of an LCD by coupling to the silanol, hydroxyl, or other reactive groups in the substrate. The silanes and titanates may have only alkoxy substitution on the Si or Ti atom connected to an adhesive copolymerizable or interactive group. Alternatively, the silanes and titanates may have both alkyl and alkoxy substituation on the Si or Ti atom connected to an adhesive copolymerizable or interactive group. The adhesion promoting additives may contain copolymerizable group that is generally an acrylate or methacrylate group, but vinyl and allyl groups may also be used. Alternatively, the silanes or titanates may also react with functional groups in the adhesive, such as a hydroxyalkyl(meth)acrylate. In addition, the silane or titanate may have one or more group providing strong interaction with the adhesive matrix. Examples of this strong interaction include, hydrogen bonding, ionic interaction, and acid-base interaction.

### Method of Making

Because the light diffusive PSA disclosed herein is manufactured using solventless system, the adhesive composition is prepared by a coat and cure technique as generally described in U.S. Pat. No. 4,181,752 (Martens).

In this technique, in one exemplary method, a solventless mixture is provided having a first refractive index n₁ and comprising (i) a monomer mixture having no greater than about 20 parts by weight of at least one of a radically polymerizable hydroxyl-containing monomer and a radically polymerizable acid-containing monomer and less than about 100 parts of an alkyl (meth)acrylate monomer, wherein the alkyl group comprises from about 4 to 12 carbon atoms; and (ii) about 0.1 to 5 parts photoinitiator. This mixture can be partially prepolymerized to yield a syrup as described in, e.g., US. Pat. No. 6,339,111 (Moon, et al.).

Often a soventless bead dispersion is prepared comprising the light diffusing particles mixed with the monomer. Also provided is a photoinitiator solution comprising from about 0.1 to 5 parts of a photoinitiator in the monomer mixture, a salt solution comprising from about 0.1 to 10 parts of antistatic agent (i.e., the organic-soluble and dissociable salt) in the monomer mixture, and a crosslinker solution comprising from about 0.01 to 20 parts crosslinker in the monomer mixture. All parts of the photoinitiator, salt, and crosslinker are based on the weight of the monomer mixture.

This adhesive composition coated on a first backing and then subjected to photochemical curing. If desired, the adhesive composition is coated between two liners or between the first and second backings.

Exemplary backings, whether first or second backing, include polycarbonates, polyesters (e.g., polyethylene terephthalates and polyethylene naphthalates), polyurethanes, poly(meth)acrylates (e.g., polymethyl methacrylates), polyvinyl alcohols, polyolefins such as polyethylenes and polypropylenes, polyvinyl chlorides, polyimides, cellulose triacetates, acrylonitrile-butadiene-styrene copolymers, and the like. Any suitable release liner can also be used for the first or second backing. Exemplary release liners include those prepared from polymeric material (e.g., polyolefins such as polyethylene or polypropylene, ethylene vinyl acetate, polyurethanes, polyesters such as polyethylene terephthalate, and the like). At least some release liners are coated with a layer of a release agent such as a silicone-containing material or a fluorocarbon-containing material. Exemplary release liners include, but are not limited to, liners commercially available from CP Film (Martinsville, Va.) under the trade designation “T-30” and “T-10” that have a silicone release coating on polyethylene terephthalate film.

The particles may be dispersed within the adhesive matrix at any stage of this process prior to coating and curing. For example, the particles may be dispersed in a monomer mixture, in the monomer mixture with added modifying agent or to the coatable syrup. For ease of dispersal, the particles are typically added to the monomer mixture or the coatable syrup.

### EXAMPLES

### Peel Adhesion Testing

This peel adhesion test is similar to the test method described in ASTM D 3330-90, substituting a glass plate as the substrate. Adhesive samples coated on a liner were transferred to PET Film and samples were cut into 1.27 centimeter by 15 centimeter strips. Each strip was then adhered to a 10 centimeter by 20 centimeter clean substrate. The strip was adhered by passing a 2-kilogram roller over the strip. The bonded sample dwelled at various time, as listed in Table 2 below, and was tested for 180° peel adhesion using an IMASS slip/peel tester (Model 3M90, commercially available from Instrumentors Inc., Strongsville, Ohio) at a rate of 30 centimeters/minute (12 inches/minute) over a five second data collection time. Measurements were obtained in ounces/inch.

### Luminous Transmission and Haze Test

The luminous transmittance and haze of all samples were measured according to American Society for Testing and Measurement (ASTM) Test Method D 1003-95-5 (“Standard Test for Haze and Luminous Transmittance of Transparent Plastic”) using a Hazegard Plus Spectrophotometer from BYK-Gardner Inc.; Silver Springs, Md. The adhesive samples were prepared by transferring the adhesive from a release liner to a glass microscope slide.

### Depolarization and Backscatter

Samples were laminated to clean microscope slides prior to measurement. Measurements were made on a Perkin Elmer Lambda 900 spectrophotometer fitted with a PELA-1000 integrating sphere accessory. This sphere is 150 mm (6 inches) in diameter and complies with ASTM methods E903, D1003, E308, et al. as published in “ASTM Standards on Color and Appearance Measurement,” 3^{rd} ed., ASTM, 1991. For Transmittance, the instrument was configured with a common beam depolarizer, an incident-beam polarizer (placed before the sample), and an analyzing, cut-sheet polarizer (placed immediately behind the sample, in front of the integrating sphere). For Reflectance, only the common beam depolarizer was used.

Total light transmission (TLT) was measured separately for Pass State (incident and analyzing plane polarizers aligned) and Block State (incident and analyzing plane polarizers crossed). We observed amount of depolarization caused by adhesive samples, indicated by the light transmitted when the samples were inserted between polarizers aligned in the Block State. The % TLT_{SampleBlock} values are reported as depolarization.

Calculation at each wavelength was done as follows:

% TLT_{SamplePass}=[(% TLT_{PSample}−% TLT_{B0})÷(% TLT_{P100}−% TLT_{B0})]*100

% TLT_{SampleBlock}=[(% TLT_{BSample}−% TLT_{B0})÷(% TLT_{P100}−% TLT_{B0})]*100

where TLT_{SamplePass} is all light transmitted in pass state, TLT_{SampleBlock} is all light transmitted (depolarized) in block state, P100 is open beam pass state, and B0 is open beam block state.

Total light reflection (TLR) and DLR was measured separately without incident and analyzing plane polarizers. Reflectance was corrected using a NIST traceable mirror. The DLR values best represent the non-specular backscatter for each sample and are reported as backscatter. Calculation for correction at each wavelength was done as follows:

% DLR_{corr}=[(% DLR_{S}−% DLR_{Mirror})÷(% TLR_{Mirror}−% DLR_{Mirror})]*(True Mirror Value)

where DLR_{S} is the DLR measured for the sample, DLR_{Mirror} is is the DLR measured for the Reference Mirror, TLR_{Mirror} is the TLR measured for the Reference Mirror, and True Mirror Value is the TLR of the Reference Mirror.

Table of Abbreviations

| Abbreviation | |
|---|---|
| or Trade | |
| Designation | Description |
| EHA | 2-ethylhexyl acrylate, available from Dow Chemical |
| | Company, Midland, Michigan |
| HEA | 2-hydroxyethyl acrylate, available from Dow Chemical |
| | Company, Midland, Michigan |
| AA | Acrylic acid, available from Dow Chemical Company, |
| | Midland, Michigan |
| HDDA | 1,6-hexanediol diacrylate, available as PHOTOMER 4017 |
| | from Cognis, Germany |
| Irg651 | Irgacure 651: 2,2-dimethoxy-2-phenylacetophenone, a |
| | photo-initiator available from Ciba Specialty Chemicals, |
| | Tarrytown, NY |
| HQ-115 | [Li⁺] [⁻N(SO₂CF₃)₂] from 3M Corporation, Saint Paul, MN |
| KBM-503 | 3-(trimethoxysilyl)propyl methacrylate from Shin-Etsu |
| | Silicones of America |
| S141 | Santicizer 141: 2-ethylhexyldiphenyl phosphate, available |
| | from Ferro Corporation, Cleveland, Ohio |
| MX1000 | PMMA beads, available from Soken Chemical America, |
| | Woodbury, MN (10 micron average diameter) |
| Tospearl | Silicone beads, available as Tospearl 145 from Momentive |
| | Performance Materials, Wilton, CT (4.5 micron average |
| | diameter) |

In all the examples that follow, the lamp intensity used for curing was not greater than 50 mW/cm².

### Example 1

A monomer premix was prepared using EHA (90 parts), HEA (10 parts), MX1000 (45 parts), and photoinitiator Irg651 (0.04 parts). This mixture was mixed and purged with nitrogen for at least 10 minutes. The mixture was then partially polymerized under a nitrogen-rich atmosphere by exposure to ultraviolet radiation to provide coatable syrup having a viscosity of about 3000 cps. To 11.5 g of this syrup was added 0.198 g of plasticizer S141, 0.396 g of a 50% solution of HQ115 in EHA, 0.040 g of a 10% solution of HDDA in EHA, and 0.087 g of a 10% solution of Irg651 in EHA. The mixture was then knife coated in-between two silicone-treated PET release liners at a thickness of 1.2 mils. The resulting composite was then exposed to ultraviolet radiation (a total energy of about 1,000 mJ/cm²) having a spectral output from 300-400 nm with a maximum at 351 nm.

### Examples 2-3

A monomer premix was prepared using EHA (90 parts), HEA (10 parts), MX1000 (22.5 parts), and photoinitiator Irg651 (0.04 parts). This mixture was mixed and purged with nitrogen for at least 10 minutes. The mixture was then partially polymerized under a nitrogen-rich atmosphere by exposure to ultraviolet radiation to provide a coatable syrup having a viscosity of about 3000 cps. To 7.08 g of this syrup was added 0.144 g of plasticizer S141, 0.289 g of a 50% solution of HQ115 in EHA, 0.029 g of a 10% solution of HDDA in EHA, and 0.064 g of a 10% solution of Irg651 in EHA. The mixture was then knife coated in-between two silicone-treated PET release liners at a thickness of 1.1 mil (Example 2) and 2.2 mils (Example 3). The resulting composite was then exposed to ultraviolet radiation (a total energy of about 1,000 mJ/cm²) having a spectral output from 300-400 nm with a maximum at 351 nm.

### Examples 4-5

A solventless syrup was prepared using EHA (95 parts), HEA (5 parts), and photoinitiator Irg651 (0.04 parts). This mixture was mixed and purged with nitrogen for at least 10 minutes. The solventless syrup was then partially polymerized under a nitrogen-rich atmosphere by exposure to ultraviolet radiation to provide coatable syrup having a viscosity of about 3000 cps. For a solventless bead dispersion, 2.505 g of MX1000 was dispersed in a 90/10 mixture of EHA/HEA to make a 33% beads dispersion. To this dispersion was added 10.55 g of partially polymerized syrup, 0.586 g of HEA, 0.278 g of plasticizer S141, 0.557 g of a 50% solution of HQ115 in EHA, 0.056 g of a 10% solution of HDDA in EHA, and 0.125 g of a 10% solution of Irg651 in EHA to yield a coatable adhesive composition. This composition was then knife coated in-between two silicone-treated PET release liners at a thickness of 1.1 mil (Example 4) and 2.0 mils (Example 5). The resulting composite was then exposed to ultraviolet radiation (a total energy of about 1,000 mJ/cm²) having a spectral output from 300-400 nm with a maximum at 351 nm.

### Example 6

A solventless syrup was prepared using EHA (95 parts), HEA (5 parts), and photoinitiator Irg651 (0.04 parts). This syrup was mixed and purged with nitrogen for at least 10 minutes. The syrup was then partially polymerized under a nitrogen-rich atmosphere by exposure to ultraviolet radiation to provide coatable syrup having a viscosity of about 3000 cps.

A solventless bead dispersion was made by dispersing 1.2 g of Tospearl beads in 3.00 g of a mixture of EHA/HEA (95/5). To this dispersion was added 20.0 g of the partially polymerized syrup, 1.00 g of a 50% solution of HQ115 in EHA, 0.100 g of a 10% solution of HDDA in EHA, and 0.220 g of a 10% solution of Irg651 in EHA to yield a coatable adhesive composition. The composition was then knife coated in-between two silicone-treated PET release liners at a thickness of 1.6 mils. The resulting composite was then exposed to ultraviolet radiation (a total energy of about 1,000 mJ/cm²) having a spectral output from 300-400 nm with a maximum at 351 nm.

### Example 7

A syrup was prepared using EHA (95 parts), HEA (5 parts), and photoinitiator Irg651 (0.04 parts). This syrup was mixed and purged with nitrogen for at least 10 minutes. The syrup was then partially polymerized under a nitrogen-rich atmosphere by exposure to ultraviolet radiation to provide coatable syrup having a viscosity of about 3000 cps. A solventless bead dispersion was made by dispersing 19.992 g of Tospearl beads in 49.98 g of a mixture of EHA/HEA (95/5). To this dispersion was added 200.0 g of the partially polymerized syrup, 9.996 g of a 50% solution of HQ115 in EHA, 1.00 g of a 10% solution of HDDA in EHA, and 2.20 g of a 10% solution of Irg651 in EHA to yield a coatable adhesive composition. This compositioin was then knife coated in-between two silicone-treated PET release liners at a thickness of 1.3 mils. The resulting composite was then exposed to ultraviolet radiation (a total energy of about 1,000 mJ/cm²) having a spectral output from 300-400 nm with a maximum at 351 nm.

### Example 8

The preparation of Example 8 was carried out essentially as described in Example 7, except that an additional 0.800 g of a 50% solution of KBM-503 was added to the solventless bead dispersion. The coating thickness was 1.4 mils.

### Example 9

A syrup was prepared using EHA (98 parts), HEA (2 parts), and photoinitiator Irg651 (0.04 parts). This syrup was mixed and purged with nitrogen for at least 10 minutes. The syrup was then partially polymerized under a nitrogen-rich atmosphere by exposure to ultraviolet radiation to provide coatable syrup having a viscosity of about 3000 cps.

A solventless bead dispersion was made by dispersing 4.998 g of Tospearl beads in 12.495 g of a mixture of EHA/HEA (98/2). To this dispersion was added 50.0 g of the partially polymerized syrup, 2.499 g of a 50% solution of HQ115 in EHA, 0.25 g of a 10% solution of HDDA in EHA, and 0.514 g of a 11% solution of Irg651 in EHA to yield a coatable adhesive composition. This composition was then knife coated in-between two silicone-treated PET release liners at a thickness of 1.5 mils. The resulting composite was then exposed to ultraviolet radiation (a total energy of about 1,000 mJ/cm²) having a spectral output from 300-400 nm with a maximum at 351 nm.

### Example 10

A syrup was prepared using EHA (98 parts), HEA (2 parts), and photoinitiator Irg651 (0.04 parts). This syrup was mixed and purged with nitrogen for at least 10 minutes. The mixture was then partially polymerized under a nitrogen-rich atmosphere by exposure to ultraviolet radiation to provide coatable syrup having a viscosity of about 3000 cps.

A solventless bead dispersion was made by dispersing 7.497 g of Tospearl beads in 18.743 g of a mixture of EHA/HEA (98/2). To this dispersion was added 50.0 g of syrup, 2.499 g of a 50% solution of HQ115 in EHA, 0.25 g of a 10% solution of HDDA in EHA, and 0.514 g of an 11% solution of Irg651 in EHA to yield a coatable adhesive composition. This composition was then knife coated in-between two silicone-treated PET release liners at a thickness of 1.0 mils. The resulting composite was then exposed to ultraviolet radiation (a total energy of about 1,000 mJ/cm²) having a spectral output from 300-400 nm with a maximum at 351 nm.

### Example 11

The preparation of Example 11 was carried out essentially as described in Example 9, except that an additional 0.50 g of AA was added to the solventless bead dispersion. The coating thickness was 1.4 mils.

TABLE 1
Optical data

| | Transmit- | Haze | Depolar- | Back- |
|---|---|---|---|---|
| Example | tance % | % | ization % | scatter % |
| 1 | 88.9 | 38.7 | 0.03 | 0.60 |
| 2 | 89.9 | 26.5 | NT | NT |
| 3 | 88.8 | 40.7 | NT | NT |
| 4 | 89.8 | 26.7 | 0.09 | 0.55 |
| 5 | 89.1 | 38.3 | 0.01 | 0.91 |
| 6 | 89.3 | 43.3 | 0.09 | 0.39 |
| 7 | 94.0 | 56.4 | 0.04 | 0.54 |
| 8 | 94.2 | 58.0 | 0.05 | 0.38 |
| 9 | 93.9 | 55.0 | 0.06 | 0.38 |
| 10 | 93.9 | 53.1 | 0.03 | 0.45 |
| 11 | 93.9 | 57.3 | 0.08 | 0.46 |
| Reference | 94.5 | 0.3 | 0.02 | 0.32 |
| (microscope slide) | | | | |

NT: not tested

TABLE 2
Adhesion data, Units are oz/inch.

| | Initial | 30 min | | 48 h |
|---|---|---|---|---|
| Example | (20-25 min RT) | 60° C. | 24 hr RT | 50° C. |
| 1 | 9.7 | 31.0 | NT | NT |
| 2 | NT | NT | NT | NT |
| 3 | 30.4 | 41.0 | NT | NT |
| 4 | NT | NT | NT | NT |
| 5 | 24.0 | 52.8 | NT | NT |
| 6 | 23.4 | 37.0 | NT | NT |
| 7 | 18.3 | NT | 20.4 | 42.9 |
| 8 | 16.6 | NT | 31.0 | 42.3 |
| 9 | 19.0 | NT | 19.3 | 63.5 |
| 10 | 16.4 | NT | 16.3 | 50.7 |
| 11 | 15.7 | NT | 17.3 | 55.5 |

NT: not tested
RT room temperature

What is claimed is:

1. A light diffusing pressure sensitive adhesive comprising:
an adhesive matrix having a first refractive index n₁ and comprising no greater than about 20 parts by weight of at least one of a radically polymerizable hydroxyl-containing monomer and a radically polymerizable acid-containing monomer and less than about 100 parts by weight of an alkyl (meth)acrylate momoner, wherein the alkyl groups comprise from about 4 to 12 carbon atoms; and
no greater than about 75 parts light diffusing particles dispersed in the adhesive matrix and having a second refractive index n₂ that differs from n₁;
wherein the light diffusing adhesive has a luminous transmission of great than about 80% as measured according to ASTM D 1003-95-5, has a haze value not less than 20%, and has a depolarization of less than about 10% as measured using wavelength in the visible spectrum of about 400 to 700 nanometer.

2. The adhesive of claim 1, wherein the adhesive matrix further comprises about 0.1 to 10 parts of an antistatic agent based on the weight of the adhesive matrix.

3. The adhesive of claim 2, wherein the antistatic agent is lithium bis(trifluoromethanesulfonyl)imide.

4. The adhesive of claim 1, wherein the acid containing monomer is acrylic acid.

5. The adhesive of claim 1, wherein the adhesive matrix further comprises a plasticizer.

6. The adhesive of claim 1 having a backscatter of less than about 20% as measured using wavelength in the visible spectrum of about 400 to 700 nanometer.

7. The adhesive of claim 1 having 180° peel adhesion value of less than about 60 ounces per inch (16.4N/25 mm) at a peel rate of about 12 inches per minute after about 48 hours of dwell at 50° C. on glass.

8. The adhesive of claim 1, wherein the alkyl (meth)acrylate momoner is selected from the group consisting of n-butyl acrylate, 2-ethyl hexyl acrylate, isooctyl acrylate, isononyl acrylate, isodecyl acrylate, and mixtures thereof.

9. The adhesive of claim 1, wherein the light diffusing particles are polymethyl methacrylate.

10. The adhesive of claim 1 attached to at least one of a polarizer and a liquid crystal cell of a display of an electronic device.

11. A method of making a light diffusing pressure sensitive adhesive comprising the steps of:
(a) providing a solventless polymer syrup having a first refractive index n₁ and comprising (i) a monomer mixture having no greater than about 20 parts by weight of at least one of a radically polymerizable hydroxyl-containing monomer and a radically polymerizable acid-containing monomer and (ii) less than about 100 parts by weight of an alkyl (meth)acrylate monomer, wherein the alkyl group comprises from about 4 to 12 carbon atoms;
(b) providing no greater than about 75 parts light diffusing particles having a second refractive index n₂ that differs from n₁, the particles dispersed in the monomer mixture;
(c) providing from about 0.1 to 5 parts of a photoinitiator;
(d) providing from about 0.01 to 20 parts crosslinker;
wherein the parts of the light diffusing particles, photoinitiator, and crosslinker are based on the weight of the monomer mixture;
(e) mixing the solventless polymer syrup, light diffusing particles, photoinitiator, and crosslinker to yield an adhesive composition;
(f) coating the adhesive composition on a first side of a first backing; and
(g) curing the adhesive composition using actinic radiation to yield a light diffusing pressure sensitive adhesive.

12. The method of claim 11 further comprising a step of providing from about 0.1 to 10 parts of an antistatic agent prior to the mixing step (e).

13. The method of claim 12, wherein the antistatic agent is lithium bis(trifluoromethanesulfonyl)imide.

14. The method of claim 11 further comprising a step of providing a plasticizer prior to the mixing step (e).

15. The method of claim 11, the light diffusing adhesive has a backscatter of less than about 20% as measured using wavelength in the visible spectrum of about 400 to 700 nanometer.

16. The method of claim 11, wherein the light diffusing adhesive has a luminous transmission of greater than about 80% as measured according to ASTM D 1003-95-5.

17. The method of claim 11, wherein the light diffusing adhesive has 180° peel adhesion value of less than about 60 ounces per inch (16.4N/25 mm) at a peel rate of about 12 inches per minute after about 48 hours of dwell at 50° C. on glass.

18. The method of claim 11, wherein the light diffusing adhesive has a haze not less than 20%.

19. The method of claim 11, wherein the light diffusing adhesive as a depolarization of less than about 10% as measured using wavelength in the visible spectrum of about 400 to 700 nanometer.

20. The method of claim 11, wherein the light diffusing particles are polymethyl methacrylate.
